(19) United States
(12) Patent Application Publication
(10) Pub. No.: US 2018/0078087 A1
(43) Pub. Date: Mar. 22, 2018

(54) Heated Cup Assembly

(71) Applicant: Josue E. Benitez, Fairview, NJ (US)

(72) Inventor: Josue E. Benitez, Fairview, NJ (US)

(21) Appl. No.: 15/272,101

(22) Filed: Sep. 21, 2016

(51) Int. Cl. A47J 36/24; H02J 50/10; H02J 7/00; H05B 1/02; A47J 41/00

(52) U.S. Cl. CPC A47J 36/2472; H02J 50/10; H02J 7/0068; H05B 2203/021; A47J 41/005; A47J 41/0072; A47J 41/0094; H05B 1/0269

(57) ABSTRACT

A heated cup assembly capable of heating the contents of the cup includes a shell that has an inner layer and an outer layer that define an internal space. The shell is cup shaped, defining a reservoir. A power module is coupled to the shell and positioned in the internal space. A plurality of heating elements is operationally coupled to the power module and positioned in the internal space. A charging unit is reversibly and operationally couplable to the power module. The inner layer and the outer layer of the shell are configured to provide a thermal barrier such that contents positioned in the reservoir are insulated. The heating elements are coupled to the power module and positioned in the internal space such that the heating elements are configured to heat the contents of the reservoir.

### BACKGROUND OF THE DISCLOSURE

### Field of the Disclosure

The disclosure relates to cup assemblies and more particularly pertains to a new cup assembly capable of heating the contents of the cup.

### SUMMARY OF THE DISCLOSURE

An embodiment of the disclosure meets the needs presented above by generally comprising a shell that has an inner layer and an outer layer that define an internal space. The shell is cup shaped, defining a reservoir. A power module is coupled to the shell and positioned in the internal space. A plurality of heating elements is operationally coupled to the power module and positioned in the internal space. A charging unit is reversibly and operationally couplable to the power module. The inner layer and the outer layer of the shell are configured to provide a thermal barrier such that contents positioned in the reservoir are insulated. The heating elements are coupled to the power module and positioned in the internal space such that the heating elements are configured to heat the contents of the reservoir.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a heated cup assembly according to an embodiment of the disclosure.

FIG. 2 is a side view of an embodiment of the disclosure.

FIG. 3 is a top cross-sectional view of an embodiment of the disclosure.

FIG. 4 is a side cross-sectional view of an embodiment of the disclosure.

FIG. 5 is a cross-sectional view of an embodiment of the disclosure.

### DESCRIPTION OF THE PREFERRED EMBODIMENT

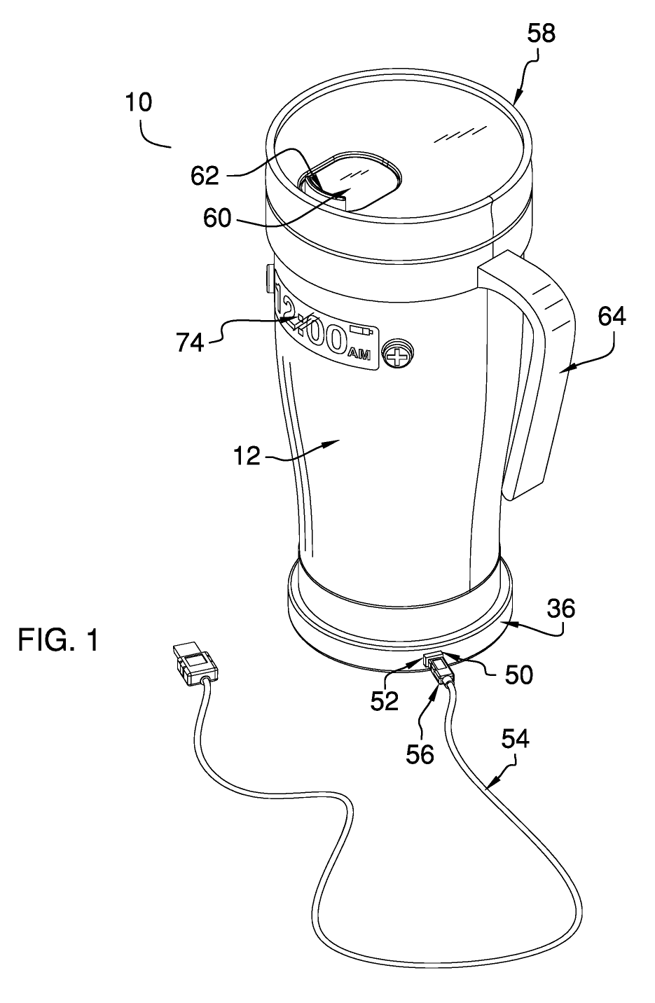

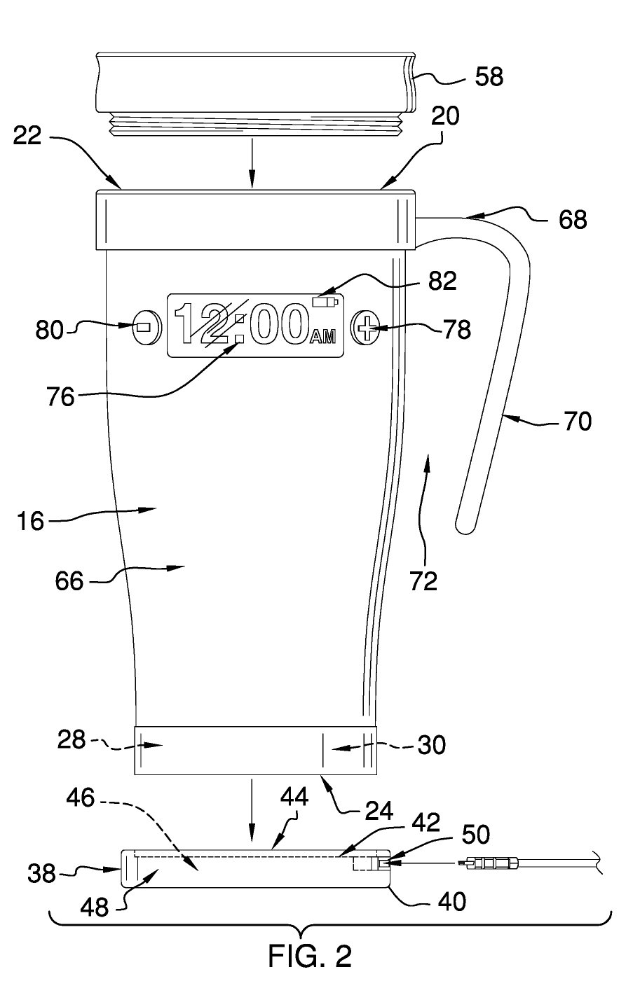

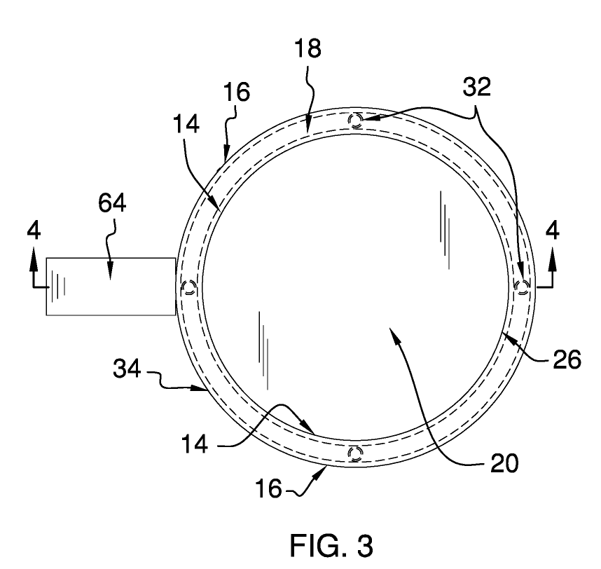

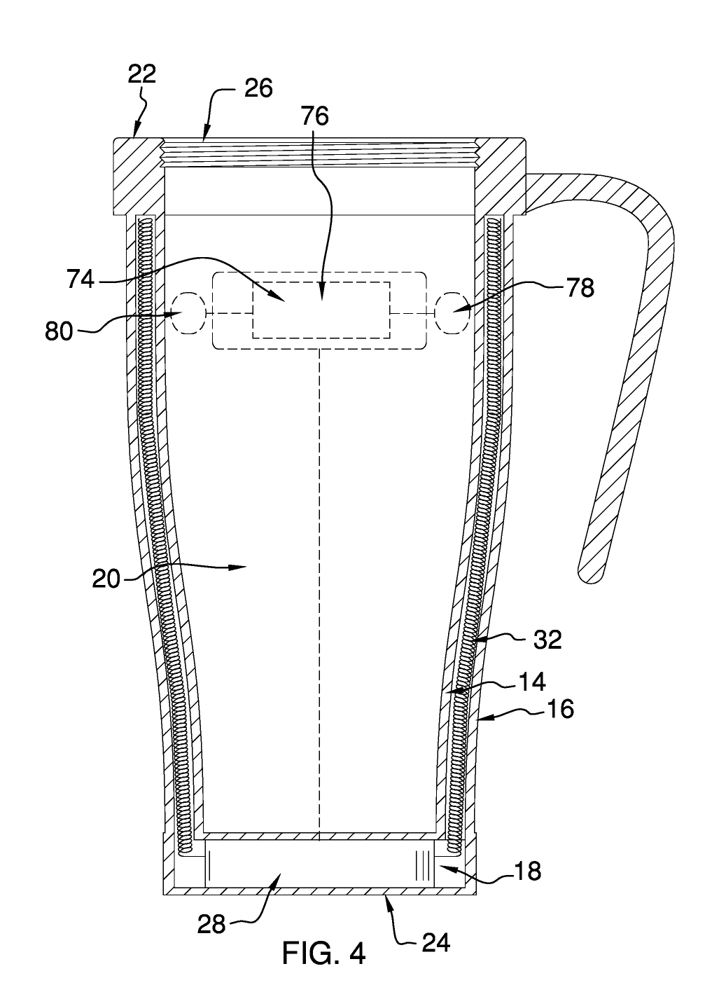

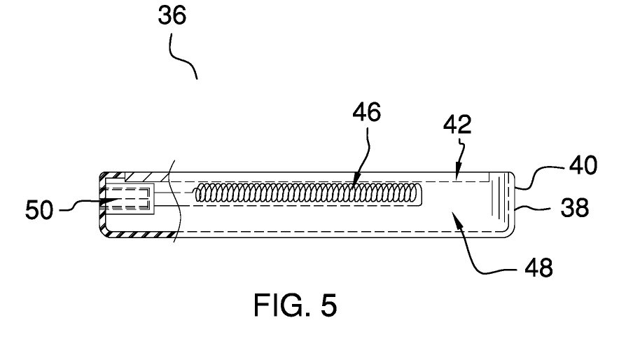

With reference now to the drawings, and in particular to FIGS. 1 through 5 thereof, a new cup assembly embodying the principles and concepts of an embodiment of the disclosure and generally designated by the reference numeral 10 will be described.

As best illustrated in FIGS. 1 through 5, the heated cup assembly 10 generally comprises a shell 12, which has an inner layer 14 and an outer layer 16 that define an internal space 18. The shell 12 is cup shaped, thus defining a reservoir 20. The shell 12 has a top 22 and a bottom 24, which is closed. The top 22 is open, thus defining a rim 26. The shell 12 is rigid and substantially cylindrically shaped.

A power module 28 is coupled to the shell 12 and positioned in the internal space 18. In one embodiment, the power module 28 is configured for wireless charging. The power module 28 comprises at least one rechargeable battery 30. The power module 28 is disc shaped. The power module 28 is positioned proximate to the bottom 24 of the shell 12.

A plurality of heating elements 32 is operationally coupled to the power module 28. The heating elements 32 are positioned in the internal space 18. Each heating element 32 extends from proximate to the bottom 24 to proximate to the top 22 of the shell 12. The plurality of heating elements 32 is substantially evenly spaced around a circumference 34 of the shell 12. In one embodiment, the plurality of heating elements 32 comprises four heating elements 32.

A charging unit 36 is reversibly and operationally couplable to the power module 28. In one embodiment, the charging unit 36 comprises a wireless charger 38. The wireless charger 38 comprises a housing 40 that is substantially disc shaped. A recess 42 that is positioned in an upper face 44 of the housing 40 is complementary to the bottom 24 of the shell 12. An inductive charger 46 is positioned in an interior space 48 of the housing 40 adjacent to the recess 42. A connector 50 is operationally coupled to the inductive charger 46. The connector 50 is configured to couple the inductive charger 46 to a power source. In one embodiment, the connector 50 comprises a universal serial bus port 52.

The wireless charger 38 also comprises a power cord 54 that is complementary to the connector 50. The power cord 54 is positioned to couple to the connector 50 such that the inductive charger 46 is couplable to the power source. In one embodiment, the power cord 54 comprises a universal serial bus plug 56. The recess 42 is positioned in the housing 40 such that the housing 40 is positioned to insert the bottom 24 of the shell 12 into the recess 42. The inductive charger 46 is positioned adjacent to the recess 42 such that the inductive charger 46 is positioned to wirelessly charge the power module 28.

The assembly 10 comprises a lid 58 that is reversibly couplable to the top 22. The lid 58 is positioned to couple to the top 22 to cover the top 22, such that contents positioned in the reservoir 20 are retained in the reservoir 20. In one embodiment, the rim 26 and the lid 58 are complementarily threaded, such that the lid 58 is threadedly couplable to the top 22.

A penetration 60 is positioned through the lid 58. The penetration 60 is positioned in the lid 58 such that the penetration 60 is adjacent to the rim 26 when the lid 58 is coupled to the top 22. A cover 62 is slidably coupled to the lid 58. The cover 62 is positioned to open and close the penetration 60.

In one embodiment, a handle 64 is coupled to and extends from an exterior surface 66 of the shell 12. The handle 64 is configured to grasp in a hand of the user. In another embodiment, the handle 64 comprises an arm 68 that is coupled to and extends substantially perpendicularly from the shell 12 proximate to the top 22. A vertical 70 is coupled to the arm 68 distal from the shell 12. The vertical 70 extends toward the bottom 24. The arm 68, the vertical 70 and the shell 12 define a slot 72 that is configured to insert one or more of the fingers of the user.

A controller 74 is coupled to the shell 12 and operationally coupled to the power module 28. The controller 74 is positioned to electrically couple the power module 28 to the heating elements 32. In one embodiment, the controller 74 comprises a display 76 that is configured to present temperature and time to the user. The display 76 is selectively backlit. The controller 74 comprises a Plus button 78 and a Minus button 80. The Plus button 78 and the Minus button 80 are configured to be depressed simultaneously a first time by the user for a first preset period of time to electrically couple the power module 28 to the heating elements 32. The Plus button 78 and the Minus button 80 are configured to be depressed simultaneously a second time by the user for the first preset time to decouple the power module 28 from the heating elements 32.

The Plus button 78 and the Minus button 80 also are configured to be depressed simultaneously by the user to a second preset period of time to toggle between temperature and time presentation. The Plus button 78 and the Minus button 80 are configured to be depressed individually and selectively by the user to adjust the time and target temperature. The controller 74 is positioned to selectively compel the heating elements 32 to heat the contents of the reservoir 20.

The display 76 also comprises an indicator 82. The indicator 82 is configured to present the degree of charge for the power module 28. The indicator 82 also is configured to blink when the power module 28 is receiving charge from the inductive charger 46. The indicator 82 also is configured to cease blinking when the power module 28 is fully charged.

The display 76 is configured to remain on when the power module 28 is coupled to the heating elements 32. The display 76 also is configured to remain on when the inductive charger 46 is positioned to wirelessly charge the power module 28. The display 76 also is configured to enter a non-backlit state after a third preset time of non-use.

In one embodiment, the shell 12 is watertight, such that the shell 12 is machine washable.

The present invention also anticipates the controller 76 being configured to set a heating level. The heating level would set an amount of power to be supplied by the power module 28 to the heating elements 32. The display 76 would be configured to present the heating level to the user.

In use, the inner layer 14 and the outer layer 16 of the shell 12 are configured to provide a thermal barrier such that contents positioned in the reservoir 20 are insulated. The heating elements 32 are coupled to the power module 28 and positioned in the internal space 18 such that the heating elements 32 are configured to heat the contents of the reservoir 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated cup assembly comprising:
a shell having an inner layer and an outer layer defining an internal space, said shell being cup shaped defining a reservoir;
a power module coupled to said shell and positioned in said internal space;
a plurality of heating elements operationally coupled to said power module and positioned in said internal space;
a charging unit reversibly and operationally couplable to said power module; and
wherein said inner layer and said outer layer of said shell are configured to provide a thermal barrier such that contents positioned in said reservoir are insulated, wherein said heating elements are coupled to said power module and positioned in said internal space such that said heating elements are configured to heat the contents of said reservoir.

2. The assembly of claim 1, further including said shell having a top and a bottom, said top being open defining a rim, said bottom being closed, said shell being rigid, said shell being substantially cylindrically shaped.

3. The assembly of claim 2, further including said power module being configured for wireless charging, said power module comprising at least one rechargeable battery, said power module being disc shaped, said power module being positioned proximate to said bottom of said shell.

4. The assembly of claim 2, further including each said heating element extending from proximate to said bottom to proximate to said top of said shell, said plurality of heating elements being substantially evenly spaced around a circumference of said shell, said plurality of heating elements comprising four said heating elements.

5. The assembly of claim 3, further including said charging unit comprising a wireless charger, said wireless charger comprising:
a housing, said housing being substantially disc shaped;
a recess positioned in an upper face of said housing, said recess being complementary to said bottom of said shell;
an inductive charger positioned in an interior space of said housing adjacent to said recess;
a connector operationally coupled to said inductive charger, wherein said connector is configured to couple said inductive charger to a power source, said connector comprising a universal serial bus port;
a power cord, said power cord being complementary to said connector, wherein said power cord is positioned to couple to said connector such that said inductive charger is couplable to the power source, said power cord comprising a universal serial bus plug; and
wherein said recess is positioned in said housing such that said housing is positioned for insertion of said bottom of said shell into said recess, wherein said inductive charger is positioned adjacent to said recess such that said inductive charger is positioned to wirelessly charge said power module.

6. The assembly of claim 2, further including a lid reversibly couplable to said top, wherein said lid is positioned to couple to said top to cover said top, such that contents positioned in said reservoir are retained in said reservoir.

7. The assembly of claim 6, further including said rim and said lid being complementarily threaded, such that said lid is threadedly couplable to said top.

8. The assembly of claim 7, further comprising:
a penetration positioned through said lid, said penetration being positioned in said lid such that said penetration is adjacent to said rim when said lid is coupled to said top; and
a cover slidably coupled to said lid, said cover being positioned to open and close said penetration.

9. The assembly of claim 1, further including a handle coupled to and extending from an exterior surface of said shell, wherein said handle is configured for grasping in a hand of the user.

10. The assembly of claim 9, further including said handle comprising:
an arm coupled to and extending substantially perpendicularly from said shell proximate to said top;
a vertical coupled to said arm distal from said shell, said vertical extending toward said bottom; and
wherein said arm, said vertical and said shell define a slot configured for insertion of one or more of the fingers of the user.

11. The assembly of claim 5, further including a controller coupled to said shell and operationally coupled to said power module, wherein said controller is positioned to electrically couple said power module to said heating elements.

12. The assembly of claim 11, further including said controller comprising a display, said display being configured to present temperature and time to the user, said display being selectively backlit.

13. The assembly of claim 12, further including said controller comprising a Plus button and a Minus button, wherein said Plus button and said Minus buttons are configured to be depressed simultaneously a first time by the user for a first preset period of time to electrically couple said power module to said heating elements and a second time by the user for the first preset time to decouple said power module from said heating elements, wherein said Plus button and said Minus button are configured to be depressed simultaneously by the user for a second preset period of time to toggle between temperature and time presentation, wherein said Plus button and said Minus button are configured to be depressed individually and selectively by the user to adjust the time and target temperature, wherein controller is positioned to selectively compel said heating elements to heat the contents of said reservoir.

14. The assembly of claim 13, further including said display comprising an indicator, said indicator being configured to present the degree of charge for said power module, said indicator being configured to blink when said power module is receiving charge from said inductive charger, said indicator being configured to cease blinking when said power module is fully charged.

15. The assembly of claim 14, further including said display being configured to remain on when said power module is coupled to said heating elements, said display being configured to remain on when said inductive charger is positioned to wirelessly charge said power module, said display being configured to enter a non-backlit state after a third preset time of non-use.

16. The assembly of claim 1, further including said shell being watertight, such that said shell is machine washable.

17. A heated cup assembly comprising:
a shell having an inner layer and an outer layer defining an internal space, said shell being cup shaped defining a reservoir, said shell having a top and a bottom, said top being open defining a rim, said bottom being closed, said shell being rigid, said shell being substantially cylindrically shaped;
a power module coupled to said shell and positioned in said internal space, said power module being configured for wireless charging, said power module comprising at least one rechargeable battery, said power module being disc shaped, said power module being positioned proximate to said bottom of said shell;
a plurality of heating elements operationally coupled to said power module and positioned in said internal space, each said heating element extending from proximate to said bottom to proximate to said top of said shell, said plurality of heating elements being substantially evenly spaced around a circumference of said shell, said plurality of heating elements comprising four said heating elements;
a charging unit reversibly and operationally couplable to said power module;
said charging unit comprising a wireless charger, said wireless charger comprising:
a housing, said housing being substantially disc shaped,
a recess positioned in an upper face of said housing, said recess being complementary to said bottom of said shell,
an inductive charger positioned in an interior space of said housing adjacent to said recess,
a connector operationally coupled to said inductive charger, wherein said connector is configured to couple said inductive charger to a power source, said connector comprising a universal serial bus port,
a power cord, said power cord being complementary to said connector, wherein said power cord is positioned to couple to said connector such that said inductive charger is couplable to the power source, said power cord comprising a universal serial bus plug, and
wherein said recess is positioned in said housing such that said housing is positioned for insertion of said bottom of said shell into said recess, wherein said inductive charger is positioned adjacent to said recess such that said inductive charger is positioned to wirelessly charge said power module;
a lid reversibly couplable to said top, wherein said lid is positioned to couple to said top to cover said top, such that contents positioned in said reservoir are retained in said reservoir, said rim and said lid being complementarily threaded, such that said lid is threadedly couplable to said top;
a penetration positioned through said lid, said penetration being positioned in said lid such that said penetration is adjacent to said rim when said lid is coupled to said top;
a cover slidably coupled to said lid, said cover being positioned to open and close said penetration;
a handle coupled to and extending from an exterior surface of said shell, wherein said handle is configured for grasping in a hand of the user, said handle comprising:
an arm coupled to and extending substantially perpendicularly from said shell proximate to said top,
a vertical coupled to said arm distal from said shell, said vertical extending toward said bottom, and
wherein said arm, said vertical and said shell define a slot configured for insertion of one or more of the fingers of the user;
a controller coupled to said shell and operationally coupled to said power module, wherein said controller is positioned to electrically couple said power module to said heating elements, said controller comprising a display, said display being configured to present temperature and time to the user, said display being selectively backlit, said controller comprising a Plus button and a Minus button, wherein said Plus button and said Minus buttons are configured to be depressed simultaneously a first time by the user for a first preset period of time to electrically couple said power module to said heating elements and a second time by the user for the first preset time to decouple said power module from said heating elements, wherein said Plus button and said Minus button are configured to be depressed simultaneously by the user for a second preset period of time to toggle between temperature and time presentation, wherein said Plus button and said Minus button are configured to be depressed individually and selectively by the user to adjust the time and target temperature, wherein controller is positioned to selectively compel said heating elements to heat the contents of said reservoir, said display comprising an indicator, said indicator being configured to present the degree of charge for said power module, said indicator being configured to blink when said power module is receiving charge from said inductive charger, said indicator being configured to cease blinking when said power module is fully charged, said display being configured to remain on when said power module is coupled to said heating elements, said display being configured to remain on when said inductive charger is positioned to wirelessly charge said power module, said display being configured to enter a non-backlit state after a third preset time of non-use;
said shell being watertight, such that said shell is machine washable; and
wherein said inner layer and said outer layer of said shell are configured to provide a thermal barrier such that contents positioned in said reservoir are insulated, wherein said heating elements are coupled to said power module and positioned in said internal space such that said heating elements are configured to heat the contents of said reservoir.
